(19) United States
(12) Patent Application Publication
(10) Pub. No.: US 2014/0231001 A1
(43) Pub. Date: Aug. 21, 2014

(54) METHOD FOR MANUFACTURING DISPLAY PANEL AND SYSTEM FOR PERFORMING THE SAME

(71) Applicant: Innolux Corporation, Miao-Li County (TW)

(72) Inventor: Ming-Te Tsai, Miao-Li County (TW)

(73) Assignee: Innolux Corporation, Miao-Li County (TW)

(21) Appl. No.: 14/158,903

(22) Filed: Jan. 20, 2014

(30) Foreign Application Priority Data
Feb. 18, 2013 (TW) 102105489

(51) Int. Cl. B32B 37/12; B32B 38/10; B32B 38/16; B32B 38/00

(52) U.S. Cl. CPC B32B 37/1284; B32B 38/0004; B32B 38/10; B32B 38/162; B32B 38/0008
USPC 156/247; 156/510; 156/379.6

(57) ABSTRACT

A multi-layered structure includes a first carrier, a second carrier, a first substrate and a second substrate. The first and second substrates are disposed between the first and second carriers. A panel sealant and a dummy sealant are positioned between the first and second substrates, wherein the panel sealant surrounds a display panel unit, and the dummy sealant is outside the panel sealant and surrounds the panel sealant. The dummy sealant to the peripheries of the first and the second substrates creates a gap. Then, glue seeps into the gap, and is cured subsequently. Next, a cutting step is performed on the first bonding structure (between the first substrate and the first carrier) and the second bonding structure (between the second substrate and the second carrier) to generate a cutting notch, respectively. The first and second carriers are peeled off from the corresponding cutting notches.

This application claims the benefit of Taiwan application Serial No. 102105489, filed Feb. 18, 2013, the subject matter of which is incorporated herein by reference.

### BACKGROUND

1. Technical Field

The disclosed embodiments relate in general to a method and a system for manufacturing display panel, and more particularly to a method and a system for manufacturing a glass-on-glass (GOG) processing display panel.

2. Description of the Related Art

Recently, manufacturers try to study and develop display panel with the thin substrate to reduce the weight and thickness of the electronic products. Flexible display panel is one of electronic products applied with the substrate thinning techniques and processes. The substrate thinning techniques involve the thinned glass substrate, the metal foil substrate, the plastic coating (ex: PET, PEN, PC) substrate, etc. It is desired that the portable device applied with the flexible display panel is be more thin and light, and would be rolled up, folded, wore as an accessory (ex: watch), or pulled the displaying area out to perform the image-enlarging action in the future. The future portable device with the flexible display panel would be easy to carry and has the larger display or the displaying image. A thin glass (0.2 mm<thickness≦0.3 mm) is taken for exemplifying a substrate of display panel, which has properties of high flexibility, low stiffness, high temperature endurance (Tg=500° C.˜700° C.), high light transmittance and low moisture permeation. However, the thin glass is easy to break or low supportability due to the insufficiency of fracture toughness and the stiffness, and can not meet the requirements of the typical apparatus for manufacturing the TFT-LCD (thickness of the substrate for the typical manufacturing apparatus: 0.3 mm<thickness≦1 mm). In the current process of thinned glass panel of LCD, two glass substrates are assembled to each other followed by filling LC molecules therebetween, and a thinning procedure such as by chemical etching and physical polishing is applied to two sides of the glass substrates to achieve the thickness of the thin glass substrate as required. However, it is difficult to performing the physical polishing, and chemical waste (such as HF or other acid) produced in the chemical etching causes serious problems of environmental contamination.

Process of thin glass panel of LCD could be divided as roll-to-roll (R2R) process and glass-on-glass (GOG) process. In the former process, a thin glass substrate stretches by two cylindrical rollers, and the related steps such as deposition, patterning and packaging (three essential steps of R2R manufacturing) are performed on the thin glass substrate. In the latter process, the thin glass substrate is attached on a thick carrier glass by the adhesive, or way of static electricity or vacuum-absorption, thereby providing sufficient strength for the thin glass substrate processed in the typical production apparatus. The carrier glass is separated from the thin glass substrate later.

When the peeling off step is performed on the GOG product, fracture or crack would be easy to occur at the thin glass substrate and/or panel sealant due to the high tension between the thick carrier and thin substrate. The yield and reliability of production are decreased consequently. For the current ODF-LCD manufactured by the GOG process, the internal force resisting to the torque (i.e. external bending force) during the carrier peeling step comes from the adhesions of panel sealant between two thin glass substrates, the adhesions of dummy sealant, and the toughness of the thin glass substrates. If the cracking sound is made during the peeling step, the panel sealant and/or thin glass substrates may be cracked or broken. In this situation, voids would be generated in the liquid crystal layer due to the vacuum loss of the display panel with cracking, thereby decreasing the yield and reliability of production.

The problems for the thin glass substrate as described above become more serious for the ultra-thin glass substrate (0.001 mm≦thickness≦0.2 mm). It is more difficult to polishing the surface of the ultra-thin glass mechanically, and the toughness of the ultra-thin glass can not bear the torque formed in the carrier peeling step, and more ultra-thin glass substrates are broken consequently. The display panel with the easy-to-break ultra-thin glass substrates could not be mass-produced due to the serious decrease of the yield.

### SUMMARY

The disclosure is directed to method and system for manufacturing display panel. According to the embodiment, an anti-cracking state is achieved by seeping and curing the glue in the gap between the peripheries of the substrates of the multi-layer structure of the display panel for adhesion, thereby peeling the carrier off the substrate of the multi-layered structure of the display panel without breaking the substrates. After peeling, the substrates and panel sealants also show no cracking or damage in the quality examination. According to the disclosure, the yield of production is increased, and the quality of the products in applications is stable.

According to one embodiment, a method for manufacturing display panel is provided, comprising: providing a multi-layered structure, comprising a first carrier, a second carrier, a first substrate and a second substrate, wherein the first and second substrates are disposed between the first carrier and the second carrier, a panel sealant and a dummy sealant are positioned between the first and the second substrates, the panel sealant surrounds a display panel unit, and the dummy sealant is outside the panel sealant and surrounds the panel sealant, the dummy sealant to the peripheries of the first and the second substrates creates a gap, and a first bonding structure is disposed between the first substrate and the first carrier while a second bonding structure is disposed between the second substrate and the second carrier; seeping a glue into the gap; curing the glue; performing a cutting step at the first bonding structure to generate a cutting notch; and peeling the first carrier off from the cutting notch.

According to one embodiment, a system for manufacturing display panel is provided, comprising a glue-dispensing unit capable of performing a glue seeping step by seeping a glue into the gap of the aforementioned multi-layered structure, a curing unit capable of curing the glue, an alignment cutting unit capable of performing an alignment cutting step at the first bonding structure of the aforementioned multi-layered structure to generate a cutting notch, and a dividing unit capable of peeling the first carrier off from the cutting notch.

### BRIEF DESCRIPTION OF THE DRAWINGS

FIG. 1 is a top view of the multi-layered structure having several display panel units according to one of the embodiments of the present disclosure.

FIG. 2 depicts a cross-sectional view of the multi-layered structure along the cross-sectional line 2-2 of FIG. 1.

FIG. 3 is a process chart showing a peeling method of the multi-layered structure according to one of the embodiments of the present disclosure.

FIG. 4 depicts the reduction of glue amount using a pointed blade according to one of the embodiments.

FIG. 5A˜FIG. 5E illustrate a method for peeling the carrier off the substrate of a multi-layered structure according to one embodiment of the disclosure.

FIG. 6 depicts relationship between curing depth and UV energy for curing adhesives A and adhesive C.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The embodiment provides method and system for manufacturing display panel to peel off the multi-layered structure of the display panel. In the embodiment, an anti-cracking state is achieved by seeping and curing the glue in the gap between the peripheries of the substrates of the multi-layer structure of the display panel for adhesion. Therefore, the substrates and panel sealants neither makes cracking sound nor be broken during the period of peeling. After peeling, the substrates and panel sealants also show no cracking or damage in the quality examination. Additionally, the applying product is also observed, and the results has indicated that the internal portion of the display panel unit is void-free, and no mura (luminance non-uniformity, such as flashlighting, clouding . . . etc) shows on the display panel while displaying the image (i.e. uniform cell gap between the substrates of the display panel). The method and system of the embodiment could be applied to the process of manufacturing GOG (Glass on Glass) display panel, to successfully peel the carrier off the substrate, particularly peeling a thick carrier off a thin substrate.

According to the aforementioned description, the carrier and the substrate, such as a thick carrier and a thin substrate, could be separated successfully by the method and system for the de-lamination the multi-layer structure of the embodiment, and at least the thin substrate is not broken. Both of the carrier and the substrate could be in excellent condition without any damage, and the panel sealant shows no cracking. Thus, the method and system for manufacturing the display panel would increase the yield of production and improve the reliability, thereby decreasing the production cost. For example, for the GOG (Glass on Glass) display panel manufacture applied by the method of the embodiment, it is successful to de-laminate the multi-layer structure, and the method is compatible with the current processing equipments. Accordingly, the method and system of the embodiment for manufacturing the display panel is suitable for the procedures of mass production, and the production cost is consequently decreased.

The embodiments are described in details with reference to the accompanying drawings. The details of the embodiment are provided for illustration, not intended to limit the 3D display of the present disclosure. Also, it is also important to point out that the illustrations may not be necessarily be drawn to scale, and that there may be other embodiments of the present disclosure which are not specifically illustrated. Thus, the specification and the drawings are to be regard as an illustrative sense rather than a restrictive sense.

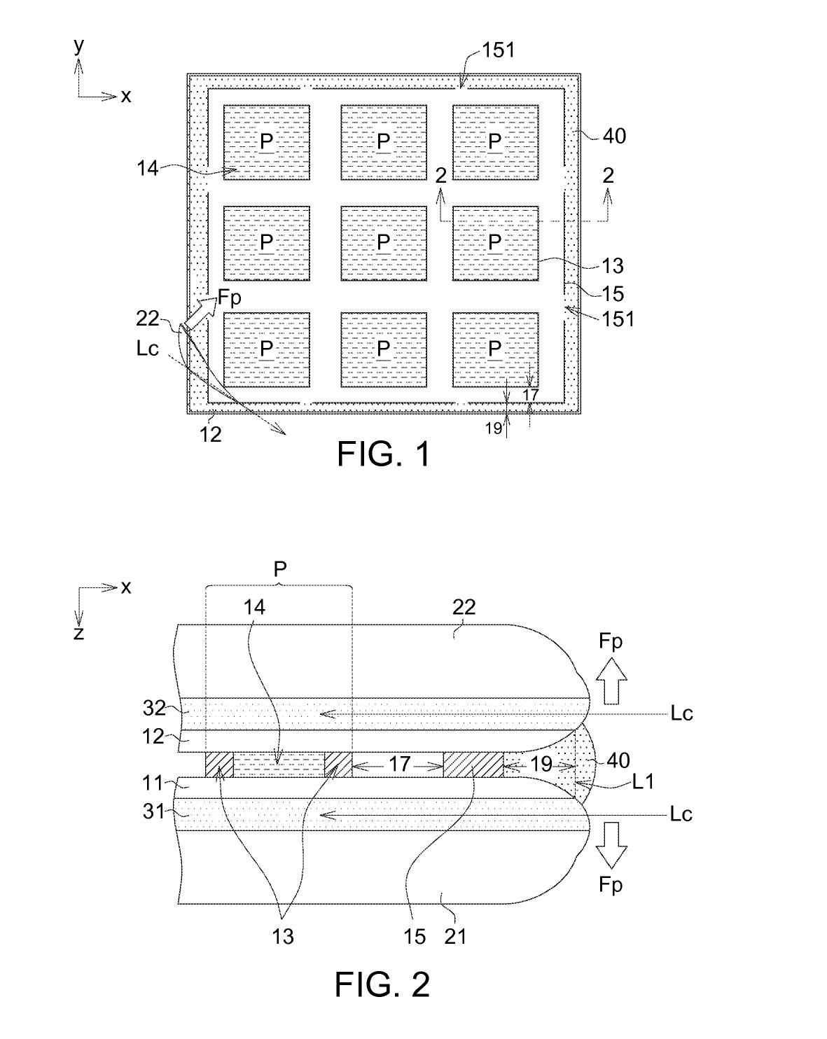

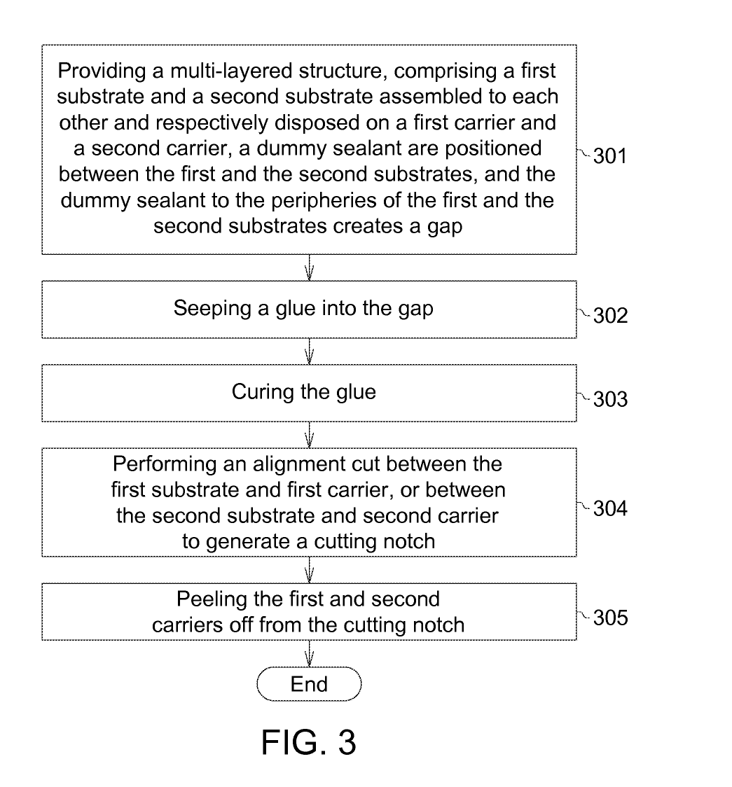

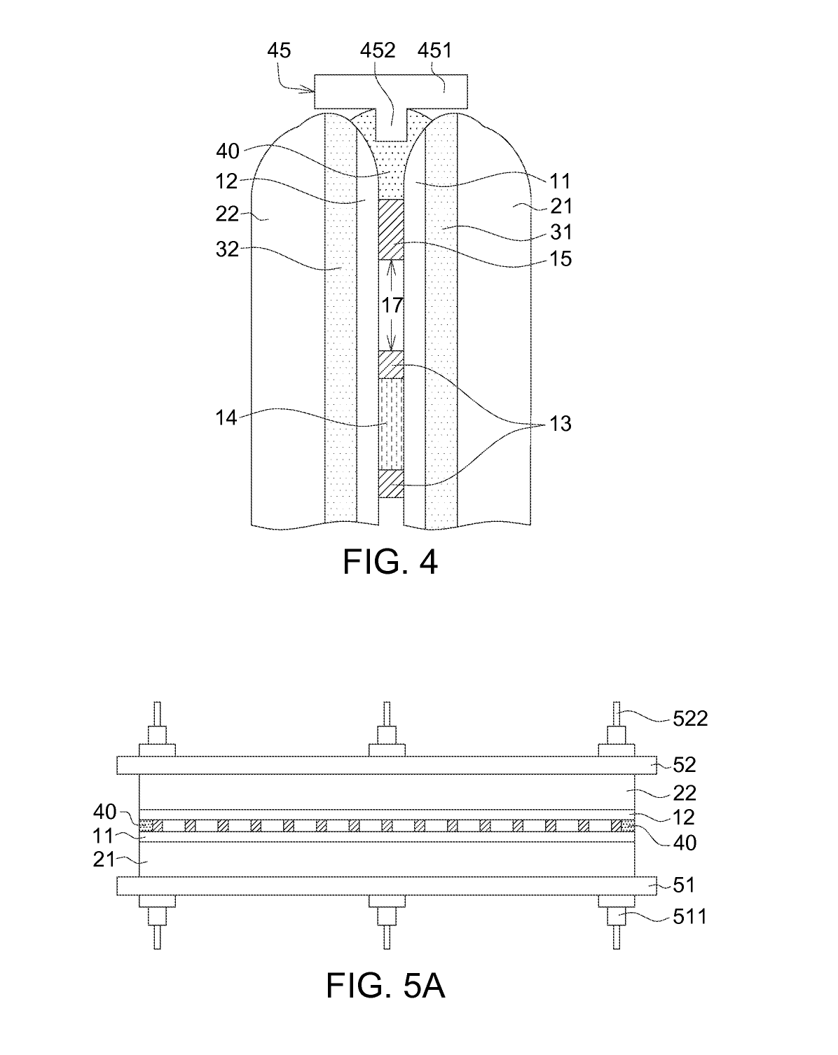

Please refer to FIG. 1, FIG. 2 and FIG. 3. FIG. 1 is a top view of the multi-layered structure having several display panel units according to one of the embodiments of the present disclosure. FIG. 2 depicts a cross-sectional view of the multi-layered structure along the cross-sectional line 2-2 of FIG. 1. FIG. 3 is a process chart showing a peeling method of the multi-layered structure according to one of the embodiments of the present disclosure.

In one embodiment, process of one drop filling (ODF) is taken for illustrating liquid crystal display manufacture in the method and system of peeling the multi-layered structure. However, the disclosure is not limited to the manufacture of liquid crystal display and the ODF fabrication.

A method for peeling a multi-layered structure of a display panel is disclosed. First, a multi-layered structure is provided, as shown in step 301. The multi-layered structure includes a first substrate 11 and a second substrate 12 assembled to each other, and the first substrate 11 is disposed at a first carrier 21 while the second substrate 12 is disposed at the second carrier 22. In the embodiment, the first carrier 21/the second carrier 22 is thicker than the first substrate 11 and the second substrate 12.

In one embodiment, the first substrate 11 and the second substrate 12 are ultra thin glass substrates, with a thickness (Tut) of equal to or larger than 0.001 mm, and equal to or less than 0.2 mm (0.001 mm≦Tut≦0.2 mm), such as 0.15 mm, 0.1 mm, 0.05 mm, or other ultra thin thickness. The ultra thin glass substrate has excellent flexibility and super light weight for being the base material of ultra thin display and flexible display. In other embodiment, the first substrate 11 and the second substrate 12 could be the thin glass substrates, with a thickness (Tt) of larger than 0.2 mm, and equal to or less than 0.3 mm (0.2 mm<Tt≦0.3 mm), such as 0.3 mm, 0.2 mm, or other thickness. The thin glass substrate has flexibility and light weight for being the base material of thin display and flexible display. In one embodiment, the first carrier 21 and the second carrier 22 are thick glass plates, with a thickness (Tc) larger than 0.3 mm, and equal to or less than 1 mm (0.3 mm<Tc≦1 mm), such as 0.5 mm, 0.7 mm, or other thickness. The thick glass plate has good toughness and stiffness, which is suitable for carrying the thin and flexible object to meet the requirements of the process flow and production equipment. In one embodiment, a thickness ratio of the carrier to the substrate is in a range of 1 to 1000.

Although glass substrates and glass carriers are exemplified in the multi-layered structure of the embodiment, the material of the substrates and carriers of the disclosure is not limited to glass. Metals, plastics, resins, glass fibers, carbon fibers or other polymer composites could be selected as the material according to the actual needs of the applications. For example, the first substrate 11 and the second substrate 12 are glass substrates, and the first carrier 21 and the second carrier 22 are plastic plates. Alternatively, the first substrate 11 and the second substrate 12 are plastic substrates, and the first carrier 21 and the second carrier 22 are glass plates. Alternatively, the first substrate 11 and the second substrate 12 are plastic substrates, and the first carrier 21 and the second carrier 22 are plastic plates. In practical application, peeling of multi-layered structure similar to the structure of FIG. 2 could be applied by the method of the disclosure with slight modification and change. Other functional layers such as touch sensors, shielding layer, anti-reflection layer or other functional layers could be formed on the side of the carrier opposite to the side bonded to the substrate.

The bonding structure between the substrate and the carrier could be an adhesive, a polyimide layer, a resin layer, an organic layer (such as ITO) or layer made of other suitable materials. Also, the substrate and the carrier could be bonded to each other by using other techniques, such as static electricity generated by rubbing the surface of substrate/carrier, or air compression by creating a low-vacuum closed region between the substrate and the carrier. As shown in FIG. 2, a first adhesive layer 31 with high temperature endurance is disposed between the first substrate 11 and the first carrier 21, and a second adhesive layer 32 with high temperature endurance is disposed between the second substrate 12 and the second carrier 22. In one embodiment, the material of the first adhesive layer 31 and the second adhesive layer 32 has high temperature endurance at 300° C.˜600° C., which is well adapted in the general manufacturing processes of display panel. In one embodiment, a thickness of laminated construction (Tlc) of a substrate, a carrier and a bonding structure is equal to or larger than 0.4 mm, and equal to or less than 1 mm (0.4 mm≦Tlc≦1 mm). In another embodiment, a thickness of laminated construction (Tlc) is in a range of 0.5 mm to 0.7 mm for adapting to the typical TFT-LCD processing equipments.

In the embodiment, the first substrate 11 and the second substrate 12 comprises several display panel units P orderly or randomly arranged; for example, arranged as an array, as shown in FIG. 1. After peeling of the multi-layered structure is completed, the assembled substrates are cut to form the independent display panel units P. A display is produced by setting the related driving components and mechanical components at each independent display panel unit. Take a TFT-LCD for example, the first substrate 11 and the second substrate 12 are mother substrates, and each of the display panel units P (as an unit of production and including thin film structures) comprise a displaying layer sandwiched between the TFT substrate (/the first substrate 11) and the CF substrate (/the second substrate 12). In one embodiment, the displaying layer of the display panel unit P is a liquid crystal layer 14. Also, the periphery of the displaying area is coated with the panel sealant 13. The TFT substrate and the CF substrate are assembled to each other by hardening the panel sealant 13, and liquid crystal molecules fill up a space enclosed by the TFT and CF substrates and the panel sealant 13. In another embodiment, the displaying layer of the display panel unit P could be an organic light-emitting diode (OLED) layer or an electrophoretic layer. When the displaying layer of the display panel unit P is an OLED layer, the panel sealant 13 would act as an encapsulation to stop the permeation of water and oxygen, thereby preventing the corrosion of OLED and prolonging the useful period of the display. Also, the TFT substrate (/the first substrate 11) of the display panel unit P may comprise a plurality of thin film transistors, a plurality of scan lines and data lines, a plurality of electrodes, a plurality of passive devices (such as capacitors, resistors), an alignment layer and a plurality of drive circuits. The CF substrate (/the second substrate 12) of the display panel unit P may comprise a plurality of color filters, electrodes, a black matrix layer, an alignment layer and spacers.

In the one-drop filling (ODF) process or substrate assembling process, a dummy sealant 15 is further disposed between the display panel unit P and the edge of the first substrate 11 and the second substrate 12. As shown in FIG. 1, the dummy sealant 15 is outside the panel sealant 13, and surrounds the panel sealant 13. The distance between the dummy sealant 15 and the edge of the first substrate 11/the second substrate 12 is determined according to process tolerances design, for preventing the yield decrease caused by the process error. In one embodiment, the dummy sealant 15 has several openings 151. With modification of the reinforcement of the dummy sealant 15 and the width of the openings 151, an active area of the display panel unit P with a uniform cell gap is obtained after assembly of the TFT and CF substrates. Accordingly, the dummy sealant 15 is positioned outside the panel sealant 13, and a blank region 17 is created between the dummy sealant 15 and the panel sealant 13, as shown in FIG. 1 and FIG. 2.

Also, the dummy sealant 15 to the peripheries of the first substrate 11 and the second substrates 12 creates a gap 19, as shown in FIG. 1 and FIG. 2. The gap 19 communicates the blank region 17 via the openings 151.

Afterward, a glue 40 is dispensed for seeping into the gap 19 by a glue-dispensing unit, as shown in step 302. The glue 40 is then cured, as shown in step 303, for adhering the peripheries of the first substrate 11 and the second substrates 12. In one embodiment, the glue-dispensing unit is a syringe having adhesive dispensing needle with a diameter of 0.2 mm˜0.3 mm or other suitable design details. In the practical application, the glue dispersion for seeping into the gap 19 could be performed by operators or machine, which is not limited in the disclosure.

In one embodiment, the glue 40 is an UV adhesive, and could be cured by irradiating with ultraviolet rays of a curing unit having an UV light source. Material examples of the glue 40 include epoxy, acrylate, a combination of epoxy and acrylate, photo-induced polymerization or low temperature-induced polymerization of polymers; however, the disclosure is not limited to those materials. If the low temperature-induced polymerization of polymer is selected as the material of the glue 40, it is noted that the temperature for curing the glue 40 should have no effect on the properties of the display panel components.

In one embodiment, a viscosity of the glue 40 is in a range of 200 cp to 20000 cp before curing. In one embodiment, the glue 40 has good flow ability before curing (ex: UV-irradiating).

In one embodiment, the glue 40 fully fills the gap 19, and forms void-free contact with the dummy sealant 15, as shown in FIG. 1 and FIG. 2. In another embodiment, the gap 19 could be partially filled with the glue 40, such as 50%˜100% of the gap 19 filled with the glue 40. In one embodiment, the glue 40 may fill into parts of the openings 151 and the blank region 17. In another embodiment, the glue 40 may overflow and touch the first adhesive layer 31 and the second adhesive layer 32 with high temperature endurance, and may also touch the first carrier 21 and the second carrier 22.

When the glue 40 at the gap 19 overflows and runs out of the edges of the first substrate 11 and the second substrate 12 to contact parts of the first carrier 21 and the second carrier 12, the experimental results have indicated that the broken issue of the first substrate 11 and the second substrate 12 is still effectively prevented by the glue 40, and the panel sealant 13 shows no cracks after the peeling process.

In another embodiment, the glue 40 at the gap 19 doesn't exceed the edges of the first substrate 11 and the second substrate 12, such as the ideal boundary L1 for amount of glue 40 depicted in FIG. 2. When the glue 40 at the gap 19 contact none of the first carrier 21 and the second carrier 12, the experimental results have indicated that the broken issue of the first substrate 11 and the second substrate 12 caused by the conventional peeling process has been completely prevented by the glue 40, and the panel sealant 13 shows no cracks, and the first carrier 21 and the second carrier 12 are also not broken or cracking. It is hypothesized that the original fulcrum (i.e. the dummy sealant 15) on which to peel the carrier is replaced by the cured glue 40, the force resisting to the torque (i.e. external bending force) is able to be decreased, thereby solving the broken issue of the ultra thin or thin substrate.

In order to achieve the ideal amount of glue, amount of the glue could be reduced by the following procedures, such as wiping, scraping or combination there of to remove a portion of glue. However, the disclosure is not limited to the procedures described herein. Other procedures capable of removing a portion of glue would be applied in the embodiment.

In the wiping procedure of the embodiment, the peripheries of the first substrate 11 and the second substrate 12 are wiped by a dust-free cloth to reduce amount of the glue 40. The overflowing glue could be partially absorbed by the dust-free cloth due to capillary action. The dust-free cloth could be clean, or soaked with a chemical solvent (such as alcohol). In practical application, the way to reduce amount of the glue 40 could be determined according to the actual seeping condition of the glue 40. For example, the peripheries of the first substrate 11 and the second substrate 12 could be wiped by a dust-free cloth soaked with alcohol, or wiped by a clean dust-free cloth followed by a dust-free cloth soaked with alcohol. Other procedures are also applicable. Selections or combination of wiping procedures depends on the actual needs of the application. In the practical application, wiping of the glue 40 could be performed by operators or machine, which is not limited in the disclosure.

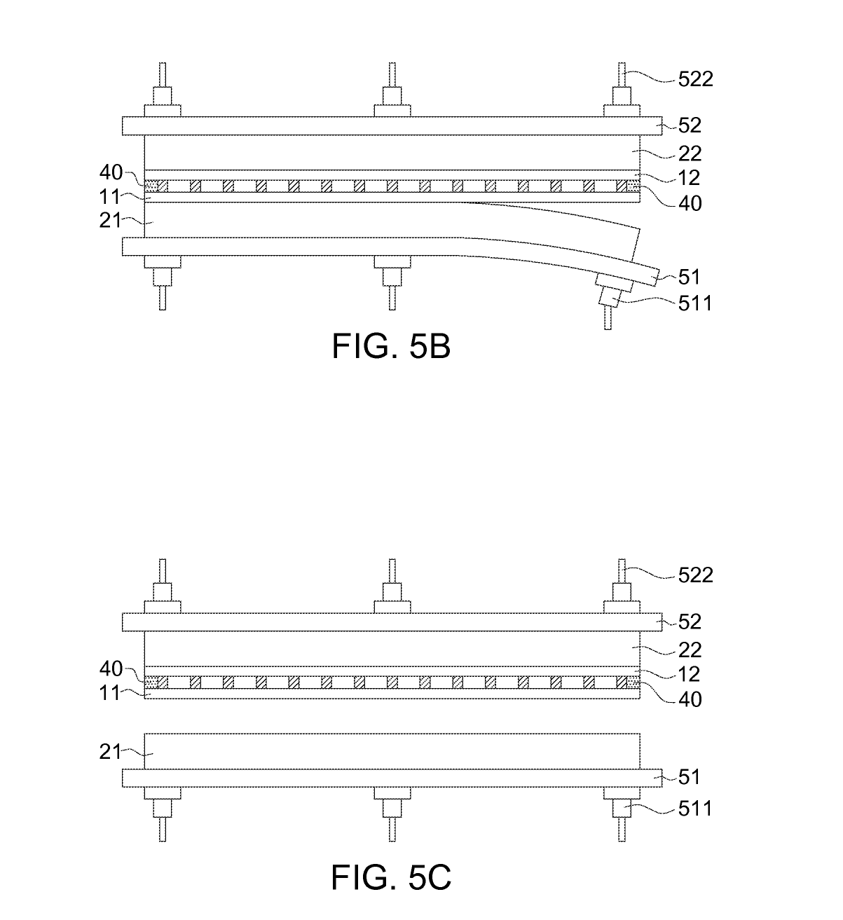

In the scraping procedure of the embodiment, a portion of the glue 40 is removed by inserting a mechanical tool (such as pointed blade or other suitable tools) into the gap 19 and moving along the gap 19 to reduce amount of the glue 40. FIG. 4 depicts the reduction of glue amount using a pointed blade according to one of the embodiments. In one embodiment, a pointed blade having a protrusion 452 protruded from the blade body 451, and the protrusion 452 is inserted into the glue 40 in the gap 19 and moved along the gap 19 to remove a portion of the glue 40, thereby reducing amount of the glue 40 and controlling the depth of the glue 40.

In one embodiment, steps of seeping, reducing and curing the glue could be performed continuously at a single side of the multi-layered structure, followed by the steps thereof performed at another side of the multi-layered structure. Accordingly, the glue formation at the long/short/long/short sides of the multi-layered structure is completed.

After finishing the seeping, reducing and curing of the glue 40, a cutting step is performed at the first adhesive layer 31 with high temperature endurance (disposed between the first substrate 11 and the first carrier 21) and the second adhesive layer 32 with high temperature endurance (disposed between the second substrate 12 and the second carrier 22) by an alignment cutting unit, as shown in step 304. The cutting notch at the adhesive layers (31/32) is generated for preparing the subsequent peeing step of the first carrier 21 and the second carrier. As shown in FIG. 1 and FIG. 2, the alignment cutting unit cuts the adhesive layers (31/32) along the predetermined cutting line Lc to generate the cutting notch. In one application, the cutting step may be performed at one of the first and second adhesive layers. For example, the cutting and peeling steps could be performed at only one carrier when the other carrier has special components or functions, such as being equipped with touch sensors or functioning as a protection layer of the display panel.

In one embodiment, the depth of the cutting notch at least corresponds to the position of the panel sealant 13 while performing the alignment cutting step. For example, the depth of the cutting notch along the predetermined cutting line Lc at least reaches the position of the display panel unit P of FIG. 2.

In another embodiment, the depth of the cutting notch exceeds the position of the panel sealant 13 while performing the alignment cutting step. For example, the depth of the cutting notch along the predetermined cutting line Lc extends to the position under the display panel unit P of FIG. 2. For example, a projection of the cutting notch overlaps the panel sealant 13 after alignment cutting.

Afterwards, the first carrier 21 on the first substrate 11 is peeled off from the cutting notch, or the second carrier 22 on the second substrate 12 is peeled off from the cutting notch, as shown in step 305. Then, the first carrier 21 or the second carrier 22 is removed. Arrow of Fp depicted in FIG. 1 and FIG. 2 indicates the peeling direction for the carrier.

Similarly, the alignment cutting step and the peeling step are performed on the other set of the substrate and the carrier, and the carrier is subsequently removed after peeling.

After peeling of the carrier(s), the residuals of the adhesive layers (i.e. the first adhesive layer 31 and the second adhesive layer 32 as shown in FIG. 2) remained on the substrates would be removed by atmospheric pressure plasma (AP plasma) or other suitable techniques. Additionally, the carriers could be subjected to the cleaning procedure for removing the adhesive residuals. The cleaned carriers could be recycled for use.

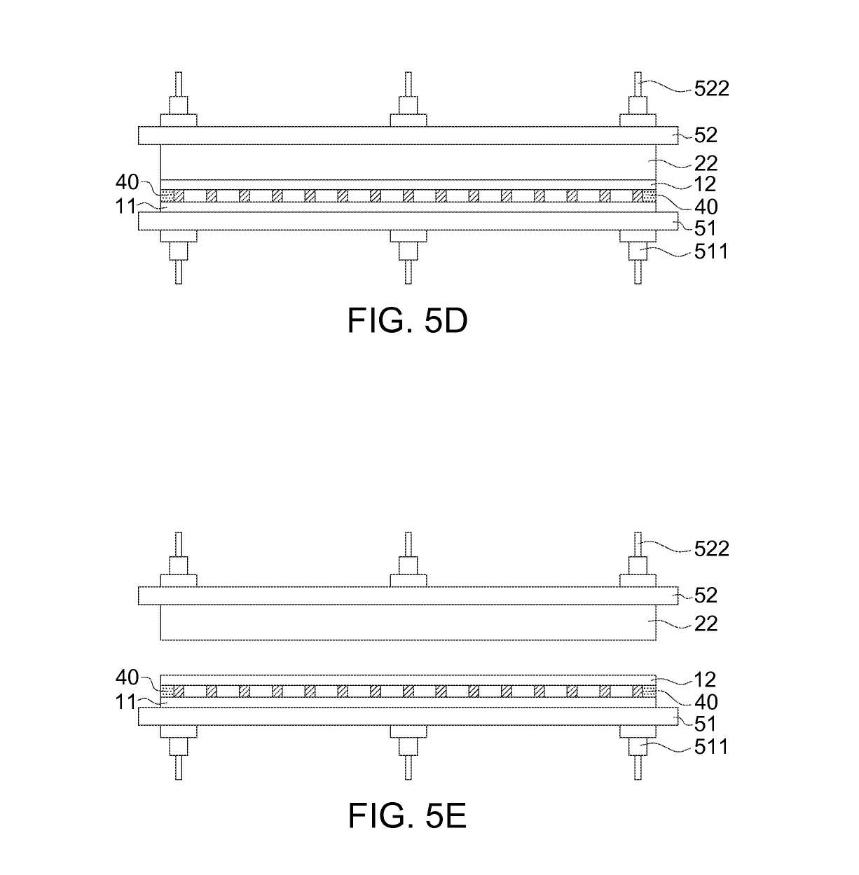

FIG. 5A˜FIG. 5E illustrate a method for peeling the carrier off the substrate of a multi-layered structure according to one embodiment of the disclosure. In the embodiment, an apparatus equipped with several vacuum heads could be adopted for carrying out the peeling of the carrier. Please refer to FIG. 2 and descriptions above for the structural details of the multi-layered structure, which are not redundantly repeated.

As shown in FIG. 5A, a dividing unit comprises a lower plate 51 and an upper plate 52, respectively equipped with several lower vacuum heads 511 and upper vacuum heads 522. The lower vacuum heads 511 and upper vacuum heads 522 are individually driven and rotated to different angles. The multi-layered structure is mounted on the dividing unit, by pressing the lower plate 51 and the upper plate 52 against two sides of the multi-layered structure. The first carrier 21 and the second carrier 22 are vacuum-adsorbed to the lower plate 51 and the upper plate 52, respectively.

As shown in FIG. 5B, the individually-controlled lower vacuum heads 511 are sequentially operated to perform the peeling procedure between the first carrier 21 and the first substrate 11. The first carrier 21 is peeled off along the cutting notch in the direction of Fp under an adequately dividing speed. After the first carrier 21 is entirely peeled off, the first carrier 21 is away from the first substrate 11 at a distance, as shown in FIG. 5C. Then, the first carrier 21 is removed from the dividing unit.

After removing the first carrier 21, the lower plate 51 is moved upwardly to press against the remained multi-layered structure with the upper plate 52.

Similarly, the individually-controlled upper vacuum heads 521 are sequentially operated to perform the peeling procedure between the second carrier 22 and the second substrate 12. The second carrier 22 is peeled off along the cutting notch in the direction of Fp under an adequately dividing speed (similar to FIG. 5B). After the second carrier 22 is entirely peeled off, the second carrier 22 is away from the second substrate 12 at a distance, as shown in FIG. 5E. After removing the second carrier 22, vacuum adsorption of the lower plate 51 closes, the assembly of the first substrate 11 and the second substrate 12 could be removed from the dividing unit. The peeling procedure is completed.

Afterwards, the singulation of the first substrate 11 and the second substrate 12 is performed to obtain the display panel units P. The slicing position is located outside the panel sealant 13 of each display panel unit P, similar to the singulation way for manufacturing the typical TFT-LCD panel.

### <Related Experiments and Results>

Several related experiments are conducted herein, by changing the glue configurations, the operation conditions (such as glue curing or position adjustment of the dummy sealant 15), and the parameters of the peeling conditions. The conditions and results of the experiments are listed in Table 1. It is noted that those condition and parameters of the experiments listed herein are for illustrating the embodiment, not for limiting the scope of the disclosure.

In Experiments E1˜E4, a D glue (commercial/trade name: WR-723) is seeped into the gap 19 (ex: TFT substrate side) between the first substrate 11 and the second substrate 12 once in one circle. In Experiment E4, a slimming glass seal (used in the glass substrate slimming process) is further seeped into the gap 19 in one circle. In Experiments E5˜E10, positions, widths or materials of the dummy sealant 15 are changed to investigate the effects of the dummy sealant 15 on the peeling procedures without setting the glue of the embodiment. In Experiments E7˜E9, the width of the dummy sealant 15 is increased. Also, the way for reducing amount of the glue 40 is wiping the peripheries of the first and second substrates by a dusty-free cloth soaked with alcohol.

TABLE 1

| | Glue and/or | Operation | Dividing | Initial Position | No. of | success rate |
|---|---|---|---|---|---|---|
| Exp. | Adhesive Setting | Conditions | Speed | of Peeling | Peeling | of Peeling |
| E1 | D glue seeping | D glue cured | 50 mm/sec | Depth of blade | 1 | 100% |
| | the gap once | by UV8000 | | insertion: 30 mm | | |
| | in one circle | | | | | |
| E2 | D glue seeping | D glue cured | 50 mm/sec | Depth of blade | 2 | 100% |
| | the gap once | by UV6000 | | insertion: 30 mm | | |
| | in one circle | | 150 mm/sec | Depth of blade | 1 | 100% |
| | | | | insertion: 30 mm | | |
| | | | | Depth of blade | 1 | 0% |
| | | | | insertion: 15 mm | | [*1] |
| E3 | D glue seeping | D glue cured | 50 mm/sec | Depth of blade | 1 | 0% |
| | the gap once | by UV4000 | | insertion: 15 mm | | [*2] |
| | in one circle | | 150 mm/sec | Depth of blade | 1 | 0% |
| | | | | insertion: 30 mm | | [*3] |
| E4 | D glue seeping | D glue cured | 50 mm/sec | Depth of blade | 2 | 100% |
| | the gap once | by UV6000 | | insertion: 30 mm | | [*4] |
| | in one circle, | | 100 mm/sec | Depth of blade | 1 | 100% |
| | followed by a | | | insertion: 30 mm | | [*5] |
| | slimming glass | | 150 mm/sec | Depth of blade | 1 | 0% |
| | seal in one | | | insertion: 30 mm | | [*6] |
| | circle | | | | | |
| E5 | □-shaped dummy | Dummy sealant | 150 mm/sec | Depth of blade | 3 | 33.3% |
| | sealant (without | modification- | | insertion: 30 mm | | |
| | drop-filling LC | changing | | | | |
| | molecule)(D glue, | pattern of | | | | |
| | cured by UV6000) | dummy sealant | | | | |
| E6 | □-shaped dummy | Dummy sealant | 150 mm/sec | Depth of blade | 3 | 33.3% |
| | sealant (without | modification- | | insertion: 30 mm | | [*7] |
| | drop-filling LC | changing | | | | |
| | molecule), and two | pattern of | | | | |
| | stripes of D glue, | dummy sealant | | | | |
| | cured by UV 6000 | | | | | |
| | for forming panel | | | | | |
| | sealants) | | | | | |
| E7 | Open loop of dummy | Dummy sealant | 150 mm/sec | Depth of blade | 2 | 100% |
| | sealant (with | in one circle, | | insertion: 30 mm | | |
| | openings), and | and each | | Depth of blade | 2 | 50% |
| | increase of the | circle formed | | insertion: 15 mm | | [*8] |
| | width of dummy | by two times | | | | |
| | sealant (D glue, | of glue | | | | |
| | cured by UV6000) | injection | | | | |
| E8 | Open loop of dummy | Dummy sealant | 150 mm/sec | Depth of blade | 2 | 0% |
| | sealant (with | in two circles, | | insertion: 30 mm | | [*9] |
| | openings), and | and each circle | | | | |
| | increase of the | formed by two | | | | |
| | width of dummy | times of glue | | | | |
| | sealant (D glue, | injection | | | | |
| | cured by UV6000) | | | | | |
| E9 | Close loop of dummy | Dummy sealant | 150 mm/sec | Depth of blade | 2 | 0% |
| | sealant (without | in two circles, | | insertion: 30 mm | | [*10] |
| | openings)(D glue, | and each circle | | | | |
| | cured by UV 6000) | formed by two | | | | |
| | | times of glue | | | | |
| | | injection | | | | |
| E10 | Panel sealant and | Dummy sealant | 150 mm/sec | Depth of blade | 2 | 50% |
| | dummy sealant by B | in one circle, | | insertion: 30 mm | | [*11] |
| | glue- change of | and each circle | | | | |
| | glue material (B | formed by one | | | | |
| | glue, S-WH08(59H, | time of glue | | | | |
| | cured by UV 8000) | injection | | | | |
| | | (S-WH08(59H)) | | | | |

[*1] All of the panel sealants show the peeling off.
[*2] CF substrate (0.2 t) is broken.
[*3] All of the panel sealants show the cracking.
[*4] There is no peeling sound during the peeling step.
[*5] There is no peeling sound during the peeling step.
[*6] The carrier (0.5 t) at the side of TFT substrate is broken. It is possible that the slimming glass seal glues the boundaries of the substrate and the carrier together and leads to the broken carrier after peeling.
[*7] The TFT substrate (0.2 t) is broken.
[*8] No problem shows when the carrier at the side of the TFT substrate is peeled first. However, all of the panel sealants show the cracking when the carrier at the side of the CF substrate is peeled subsequently.
[*9] Abnormal condition of ODF-LC molecules is observed.
[*10] All of the panel sealants show the cracking.
[*11] The CF substrate (0.2 t) is broken.

According to the results of Experiments E1, E2 and E4, the carrier is successfully peeled off the substrate according to the method of the embodiment. In Experiment E2, 15 mm of depth of blade insertion is too shallow, so that all of the panel sealants show the cracking after peeling. In Experiment E4, when the dividing speed of peeling reaches or higher than a value (ex: 150 mm/sec of dividing speed), the carrier is broken carrier after peeling. It is possible that the slimming glass seal glues the boundaries of the substrate and the carrier together and leads to the broken carrier after peeling.

According to the results of Experiment E3, the carrier is not successfully peeled off the substrate. The possible reason is that the UV energy for curing the glue (UV4000) is too low, resulting that the adhesion strength of the glue is not enough to secure the peripheries of the first and second substrates.

According to the results of Experiments E5˜E10, merely modification or pattern change of the dummy sealant 15 without forming the glue as described in the embodiment can not peels the thick carrier off the thin substrate successfully as achieved by the embodiment.

### <Materials and Properties of Adhesives as Glue>

Three materials of the glues applied to the embodiment are listed in Table 2. According to the properties of the adhesives A-C, they are applicable for being the glue 40 of the peeling method of the embodiment.

TABLE 2

| | Unit | Adhesive A | Adhesive B | Adhesive C |
|---|---|---|---|---|
| Manufacturer | | ThreeBond | ThreeBond | SeaEn |
| Main | | Epoxy + | Epoxy + | Epoxy + |
| Components | | Acrylic | Acrylic | Acrylic |
| Curing Method | | UV | UV | UV |
| Curing | mJ/cm² | 2500-3000 | 2500-3000 | 2500-3000 |
| Condition | (UV | | | |
| | Energy) | | | |
| Viscosity | mPa · s | 1100 | 1200 | 1200 |
| (25° C.) | (cp) | | | |
| Appearance | | Light | Light | Light |
| | | yellow | yellow | yellow |
| Hardness | shore D | 75 | 65 | 78 |
| Water | % | 5.2 | 3.2 | 2.74 |
| Absorption | | | | |
| Moisture | q/cm² · 24 h | NA | NA | 43.8 |
| Permeability | | | | |
| Tensile | N/mm | 12.8 | NA | 13.76 |
| Strength | | | | |
| Weight loss | kg/cm² | NA | NA | <0.5% |
| under 15% of | | | | |
| HF for | | | | |
| 24 hours | | | | |
| Adhesion after | | Δ(OK) | Δ(OK) | ◯(Good) |
| dipping in | | | | |
| 15% of HF | | | | |
| Curing | mm | 0.39 | NA | 1.54 |
| Depth-black | | | | |
| condition | | | | |

In related experiments, the UV-polymerization type adhesives A-C are evaluated, by observing the curing depths of the adhesives, to determine whether the adhesives A-C are suitable for being the glue 40 of the embodiment. Table 3 lists the properties of the adhesives A-C such as viscosity and curing depth. Table 4 lists the evaluation results of odor, adhesion and yield of the adhesives A-C. The results of Table 4 have indicated that the adhesives A-C are applicable for being the glue 40 of the embodiment.

TABLE 3

| | | Adhesive B | | | Adhesive C | Adhesive A |
|---|---|---|---|---|---|---|
| Properties | Chemical Component | Epoxy + Acrylic | | | Epoxy + Acrylic | Epoxy + Acrylic |
| of Adhesive | Viscosity (mPa · s) | 910 | 1080 | 1320 | 1300 | 1000 |
| | Quantum of UV | 3000 | 3000 | 3000 | 3000 | 3000 |
| | Energy (mJ/cm²) | | | | | |
| four-sides | Curing depth in | 5-6 mm | 5-6 mm | 5-6 mm | 4-5 mm | 5-6 mm |
| seeping of | average | | | | | |
| Adhesive | | | | | | |

TABLE 4

| | Adhesive A | Adhesive B | Adhesive C |
|---|---|---|---|
| Curing depth | 5-6 mm | 5-6 mm | 4-5 mm |
| Odor | No | No | No |
| Adhesion | Δ(OK) | Δ(OK) | ◯(Good) |
| Yield | ◯(Good) | ◯(Good) | ◯(Good) |

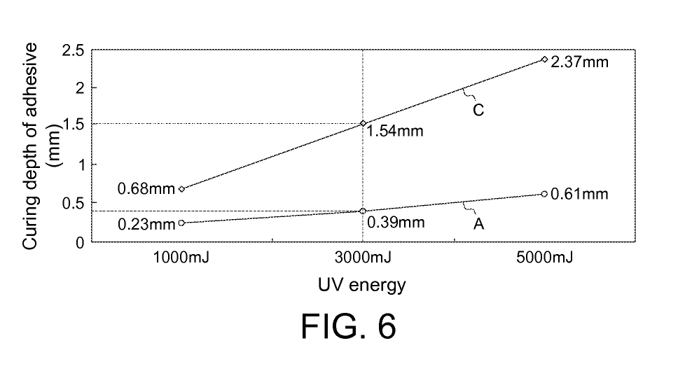

FIG. 6 depicts relationship between curing depth and UV energy for curing adhesives A and adhesive C. As shown in FIG. 6, the adhesive A cured by the UV energy of 1000 mJ/cm², 3000 mJ/cm² and 5000 mJ/cm² has the curing depths of 0.23 mm, 0.39 mm and 0.61 mm, respectively. The adhesive C cured by the UV energy of 1000 mJ/cm², 3000 mJ/cm² and 5000 mJ/cm² has the curing depths of 0.68 mm, 1.54 mm and 2.37 mm, respectively.

Practically, after decision of the adhesive (for being the glue of the embodiment) has been made, the related parameters would be adjusted according to the physicochemical characteristics of the adhesive and the results to be achieved. For example, the viscosity of the adhesive could be adjusted according to the curing depth to be achieved, and an adequate UV energy for cuing the adhesive is also selected.

According to the aforementioned description, the carrier and the substrate, such as a thick carrier and a thin substrate, could be separated successfully by the method and system for the de-lamination the multi-layer structure of the embodiment, and at least the thin substrate is not broken. Both of the carrier and the substrate could be in excellent condition without any damage, and the panel sealant shows no cracking. Thus, the method and system for manufacturing the display panel would increase the yield of production and improve the reliability, thereby decreasing the production cost. For example, for the GOG (Glass on Glass) display panel manufacture applied by the method of the embodiment, it is successful to de-laminate the multi-layer structure, and the method is compatible with the current processing equipments. Accordingly, the method and system of the embodiment for manufacturing the display panel is suitable for the procedures of mass production, and the production cost is consequently decreased.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for manufacturing display panel, comprising:
providing a multi-layered structure, comprising:
a first carrier, a second carrier, a first substrate and a second substrate, wherein the first and second substrates are disposed between the first carrier and the second carrier, a panel sealant and a dummy sealant are positioned between the first and the second substrates, the panel sealant surrounds a display panel unit, and the dummy sealant is outside the panel sealant and surrounds the panel sealant, the dummy sealant to the peripheries of the first and the second substrates creates a gap, and a first bonding structure is disposed between the first substrate and the first carrier while a second bonding structure is disposed between the second substrate and the second carrier;
seeping a glue into the gap;
curing the glue;
performing a cutting step at the first bonding structure to generate a cutting notch; and
peeling the first carrier off from the cutting notch.

2. The method according to claim 1, wherein the glue into the gap doesn't exceed peripheral edges of the first and the second substrates.

3. The method according to claim 1, wherein the glue is an UV adhesive, and irradiated by ultraviolet rays for curing.

4. The method according to claim 1, wherein a viscosity of the glue before curing is in a range of 200 cp to 20000 cp.

5. The method according to claim 1, further comprising wiping the peripheries of the first and the second substrates to reduce amount of the glue.

6. The method according to claim 1, further comprising removing a portion of the glue by inserting and moving a pointed blade along the gap to reduce amount of the glue.

7. The method according to claim 1, wherein a projection of the cutting notch overlaps the panel sealant while performing the cutting step.

8. The method according to claim 1, further comprising:
performing the cutting step at the second bonding structure to generate a cutting notch of the second bonding structure; and
peeling the second carrier off from the cutting notch of the second bonding structure.

9. A system for manufacturing display panel, comprising:
a glue-dispensing unit, capable of performing a glue seeping to a multi-layered structure, wherein the multi-layered structure comprises a first carrier, a second carrier, a first substrate and a second substrate, the first and second substrates are disposed between the first carrier and the second carrier, a panel sealant and a dummy sealant are positioned between the first and the second substrates, the panel sealant surrounds a display panel unit, and the dummy sealant is outside the panel sealant and surrounds the panel sealant, the dummy sealant to the peripheries of the first and the second substrates creates a gap, and a first bonding structure is disposed between the first substrate and the first carrier while a second bonding structure is disposed between the second substrate and the second carrier, and the glue-dispensing unit seeps a glue into the gap;
a curing unit, capable of curing the glue;
an alignment cutting unit, capable of performing an alignment cutting step at the first bonding structure to generate a cutting notch; and
a dividing unit, capable of peeling the first carrier off from the cutting notch.

10. The system according to claim 9, wherein the glue in the gap doesn't exceed peripheral edges of the first and the second substrates.

11. The system according to claim 9, wherein the glue is an UV adhesive, and the curing unit is an UV-irradiating unit.

12. The system according to claim 9, further comprising a glue-reduction unit for reducing amount of the glue, wherein the glue-reduction unit wipes the peripheries of the first and the second substrates, or removes a portion of the glue by inserting and moving a pointed blade along the gap, or acts by a combination thereof to reduce amount of the glue.

13. The system according to claim 9, wherein a projection of the cutting notch overlaps the panel sealant while the alignment cutting step is performed by the alignment cutting unit.

14. The system according to claim 9, wherein the alignment cutting unit further performs the alignment cutting step at the second bonding structure to generate a cutting notch of the second bonding structure, and the peeling unit peels the second carrier off from the cutting notch of the second bonding structure.

15. The system according to claim 9, wherein a sum of thicknesses of the first substrate, the first carrier and the first bonding structure is 0.4 mm or larger to 1 mm or less.
